(19) United States
(12) Patent Application Publication
(10) Pub. No.: US 2026/0283071 A1
(43) Pub. Date: Sep. 24, 2026

(54) VEGETATION TRIMMER CUTTING HEAD

(71) Applicant: Thomas L. Warren, Westhampton, MA (US)

(72) Inventor: Thomas L. Warren, Westhampton, MA (US)

(21) Appl. No.: 19/085,096

(22) Filed: Mar. 20, 2025

(51) Int. Cl. A01D 34/83; A01D 34/90; A01D 101/00

(52) U.S. Cl. CPC A01D 34/831; A01D 34/90; A01D 2101/00

(57) ABSTRACT

A vegetation trimmer cutting head is provided, which includes an elongate cutting guard frame, sets of, spaced, comb-like, channeling teeth positioned on either side of the cutting guard frame, and an endless cutting belt having a cutting path. During operation of the vegetation trimmer cutting head, the spaced, comb-like, channeling teeth channel or guide vegetation into the cutting path of the endless cutting belt, while at the same time preventing objects such as mailbox posts, fence posts, and older headstones made from soft materials like marble or limestone, in proximity to the trimmer cutting head from contacting blades on the endless cutting belt.

### TECHNICAL FIELD

The present invention relates generally to a vegetation (e.g., grass and plant) trimmer cutting head in the form of a small, handheld tool for trimming around edges, tight corners, and obstacles where a lawn mower cannot reach. In an exemplary embodiment, the trimmer cutting head uses sets of spaced, comb-like, channeling teeth to channel vegetation into the cutting path of a cutting belt, while preventing objects (e.g., mailbox posts, fence posts, older headstones made from soft materials like marble or limestone, etc.) in close proximity to the trimmer cutting head during operation from contacting blades on the cutting belt.

### BACKGROUND OF THE INVENTION

Grass trimmers with cutting string (i.e., weed whackers) are used to cut grass, weeds, and other vegetation in hard-to-reach places around trees, shrubs, mailbox posts, older, softer headstones, and other obstacles. These trimmers trim edges of lawns by a motor driven flexible wire or a plastic or nylon type cord or blade. These trimmers, however, are known to cause damage to a yard by eroding the surface of mailbox, fence, and deck posts, damaging the bark of trees and shrubs, scalping grass, and disturbing the soil around plants. By way of example, mailbox, fence, and deck posts may be made from wood, plastic, or metal. While cutting grass and weeds about the base of these posts, it is extremely difficult, if not impossible, to avoid hitting the posts. The trimmers constantly striking the posts cause unsightly indentations such as grooves and cuts in the post's surface. The indentations can often attract dirt and debris that can also become discolored and tend to shorten the lifespan of the posts.

Thus, a need exists for a trimmer which avoids the problems associated with grass trimmers with cutting string.

### SUMMARY OF THE INVENTION

The present invention addresses this need by providing a vegetation trimmer cutting head that during its operation serves to protect trees, shrubs, posts, older, softer headstones, and other obstacles found in a yard or other outdoor space. In particular, the inventive vegetation trimmer cutting head employs sets of spaced, comb-like, channeling teeth and a cutting belt having a cutting path, wherein during operation of the handheld vegetation trimmer cutting head, the spaced, comb-like, channeling teeth channel vegetation into the cutting path of the cutting belt, while preventing objects in proximity to the trimmer cutting head from contacting the cutting belt.

In an exemplary embodiment, the inventive trimmer cutting head comprises:
an elongate cutting guard frame having a longitudinal axis and perimeter, and a set of spaced, comb-like, channeling teeth positioned at least along each opposing longitudinal side of the guard frame;
at least two pulleys, namely, a drive pulley and an idle pully, disposed on opposing distal ends of the guard frame; and
an endless cutting belt having a plurality of spaced cutting blade inserts partially embedded therein, wrapped around the drive pulley and the idle pully, and movable along a cutting path, the cutting belt set back or offset from the perimeter of the guard frame,
wherein, each set of comb-like, channeling teeth work in cooperation with the cutting blade inserts by channeling vegetation into the cutting path of the cutting belt, while preventing objects in proximity to the trimmer from contacting the cutting blade inserts.

In a preferred embodiment, the cutting blade inserts each comprise a cutting blade portion and an anchoring portion, wherein each cutting blade portion has dual cutting edges.

In a more preferred embodiment, the cutting blade portion has two opposing side cutting edges and a longitudinally extending top edge, and the anchoring portion comprises a pair of legs spaced apart from one another, projecting downwardly from the cutting blade portion.

In yet a more preferred embodiment, the anchoring portion of the cutting blade inserts have a similar or a dissimilar pair of legs selected from the group of a pair of barbed legs, a pair of staple-like legs, or a combination of a barbed leg and a staple-like leg.

In another preferred embodiment, the elongate cutting guard frame has a central channel that extends along the entire longitudinal axis of the frame, the central channel having a base and opposing side walls, with each opposing set of spaced, comb-like, channeling teeth extending substantially perpendicularly from an opposing side wall.

In yet another preferred embodiment, the inventive trimmer cutting head further comprises a front nose guard plate, which is an arch shaped plate with a solid top or crown, and book matched curved, spaced, comb-like, channeling teeth on either side of the solid top or crown on the arch shaped plate, which complements and connects the sets of comb-like, channeling teeth of the frame.

The present invention also provides a handheld vegetation trimmer cutting head, which comprises the vegetation trimmer cutting head described above, and a handle, which extends therefrom to hold and guide the trimmer cutting head. A motor may be internally housed within the handle to power the cutting head.

The present invention further provides a method for trimming vegetation, which method comprises using the handheld vegetation trimmer cutting head described above to trim grass and plants in areas of a yard where a lawn mower cannot reach (e.g., around trees, scrubs and fences, along walkways, patios, and flower beds, on steep slopes, etc.).

Other features and advantages of the invention will be apparent to one of ordinary skill from the following detailed description. Unless otherwise defined, all technical and scientific terms used herein have the same meaning as commonly understood by one of ordinary skill in the art to which this invention belongs.

All publications, patent applications, patents and other references mentioned herein are incorporated by reference in their entirety. In case of conflict, the present specification, including definitions, will control. In addition, the materials, methods, and examples are illustrative only and not intended to be limiting.

### BRIEF DESCRIPTION OF THE DRAWINGS

The present disclosure may be better understood with reference to the following drawings. Matching reference numerals designate corresponding parts throughout the drawings, and components in the drawings are not necessarily to scale, emphasis instead being placed upon clearly illustrating the principles of the present disclosure.

While exemplary embodiments are disclosed in connection with the drawings, there is no intent to limit the present disclosure to the embodiment or embodiments disclosed herein. On the contrary, the intent is to cover all alternatives, modifications, and equivalents.

Particular features of the disclosed invention are illustrated by reference to the accompanying drawings in which:

FIG. 1 is a perspective view of an exemplary embodiment of the vegetation trimmer cutting head of the present invention;

FIG. 2 is an exploded view of the exemplary embodiment shown in FIG. 1;

FIG. 3 is a perspective view of a lower surface of the elongate cutting guard frame of the exemplary embodiment of the vegetation trimmer cutting head shown in FIG. 1;

FIGS. 4A, 4B, 4C are end views of exemplary embodiments of the elongate cutting guard frame of the exemplary embodiment of the trimmer cutting head shown in FIG. 1;

FIGS. 5A, 5B are perspective views of exemplary embodiments of the front nose guard plate of the exemplary embodiment of the trimmer cutting head shown in FIG. 1, with FIG. 5A showing the nose guard plate with through-holes for receiving fastening means, and with FIG. 5B showing the nose guard plate with a pair of affixed threaded studs, both for securing the front nose guard plate to the elongate cutting guard frame of the exemplary embodiment of the trimmer cutting head shown in FIG. 1;

FIG. 6 is a perspective view of an exemplary embodiment of the drive pulley of the exemplary embodiment of the trimmer cutting head shown in FIG. 1, while FIG. 6A is a cross-section of the drive pulley shown in FIG. 6 along lines 6A;

FIG. 7 is a perspective view of an exemplary embodiment of the drive pulley mount of the exemplary embodiment of the trimmer cutting head shown in FIG. 1;

FIG. 8 is a perspective view of an exemplary embodiment of idle pulley of the exemplary embodiment of the trimmer cutting head shown in FIG. 1;

FIG. 9 is a perspective view of an exemplary embodiment of the standoff bushing of the exemplary embodiment of the trimmer cutting head shown in FIG. 1;

FIG. 10 is a perspective view of an exemplary embodiment of the endless cutting belt of the exemplary embodiment of the trimmer cutting head shown in FIG. 1 with a plurality of spaced cutting blade inserts partially embedded therein;

FIG. 11 is a perspective view of an exemplary embodiment of a cutting blade insert of the exemplary embodiment of the trimmer cutting head shown in FIG. 1 with a “center curve” profile and barbed legs, while FIGS. 11A-11H are perspective views of the cutting blade insert with different cutting edge profiles and barbed legs;

FIG. 12 is a perspective view of another exemplary embodiment of a cutting blade insert of the exemplary embodiment of the trimmer cutting head shown in FIG. 1 with a “center curve” profile and staple-like legs, while FIGS. 12A-12H are perspective views of the cutting blade insert with different cutting edge profiles and staple-like legs; and

FIG. 13 is a perspective view of an exemplary embodiment of the gear head mounting bracket of the exemplary embodiment of the trimmer cutting head shown in FIG. 1.

### DETAILED DESCRIPTION OF THE INVENTION

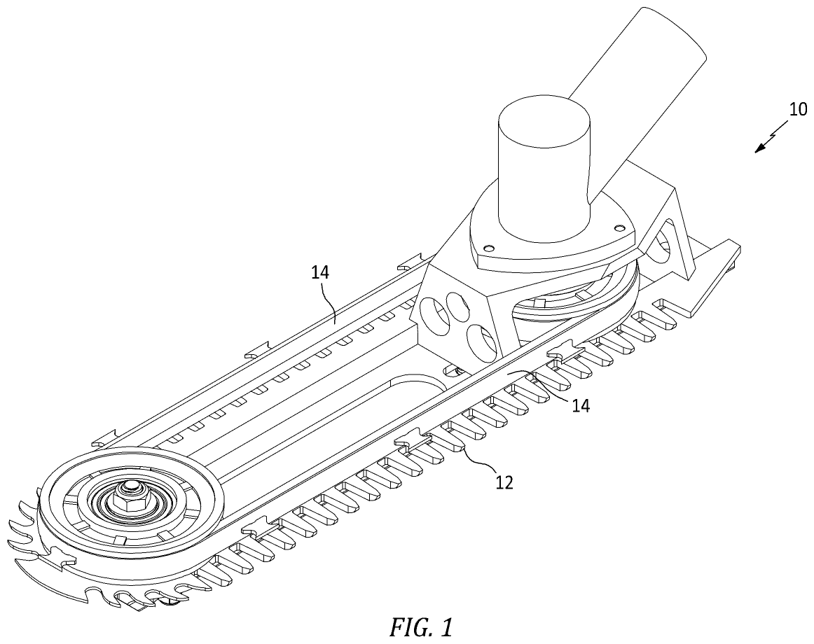

Referring now to the drawings in detail, reference numeral 10 has been used to denote an exemplary embodiment of the inventive vegetation trimmer cutting head invention. As shown in FIG. 1, trimmer cutting head 10 includes sets of spaced, comb-like, channeling teeth 12 and an endless cutting belt 14. During operation, the spaced, comb-like, channeling teeth 12 channel grass and plants into the cutting path of the endless cutting belt 14, while preventing objects in proximity to the trimmer from contacting the cutting belt 14.

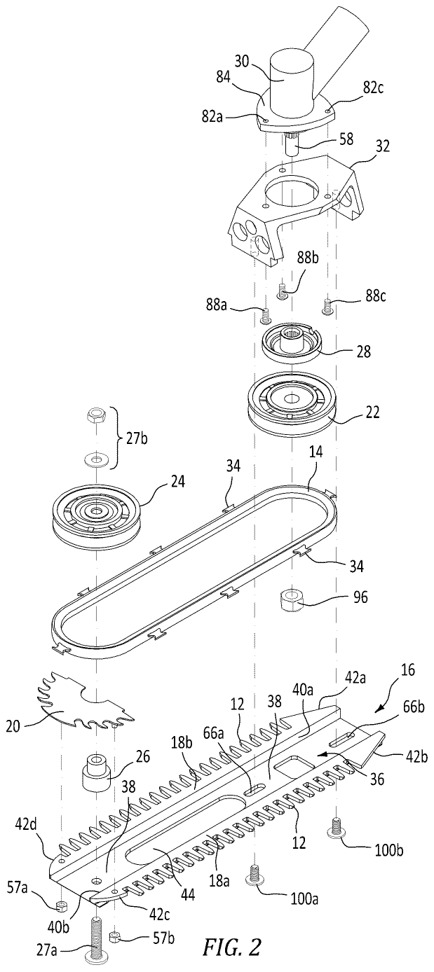

As best shown in FIG. 2, this embodiment of the inventive trimmer cutting head 10 is made up of a elongate cutting guard frame 16, having a longitudinal axis and outer perimeter, and a set of spaced, comb-like, channeling teeth 18a, 18b, positioned along each opposing longitudinal side of the guard frame 16. A nose guard plate 20 is positioned on a distal end of the guard frame 16. A drive pulley 22 and an idle pully 24 are disposed on opposing distal ends of the guard frame 16, with the idle pulley 24 positioned on a stand-off bushing 26 fixably attached to the guard frame 16, and over a portion of the nose guard plate 20. The drive pulley 22 is positioned below: a drive pulley mount 28; and an optionally articulating gear head 30, which is fixably attached to a gear head mounting bracket 32, which is fixably attached to the guard frame 16. A handle (not shown) extends from the gear head to hold and guide the trimmer cutting head 10. The cutting belt 14, which has a plurality of spaced cutting blades 34 partially embedded therein, is wrapped around the drive pulley 22 and the idle pully 24, and is movable along a cutting path. The cutting belt 14 is set back or offset from the perimeter of the guard frame 16.

The elongate trimmer cutting head of the present invention is relatively lightweight, with a preferred weight ranging from about 0.45 to about 0.91 kilograms (kg) (more preferably, from about 0.51 to about 0.74 kg).

The elongate cutting guard frame may also include a safety shield (not shown) in the form of, for example, a rigid wire mesh guard attached to an inside side wall of the guard frame and extending up and over the cutting belt and cutting blade inserts but only to an extent so as not to interfere with the operation of the inventive device.

### Elongate Cutting Guard Frame

The elongate cutting guard frame 16 serves several functions. During operation, the spaced, comb-like, channeling teeth 12 of the guard frame 16 channel grass and plants into the cutting path of the cutting belt 14, while preventing objects (e.g., mailbox posts, fence posts, trees, etc.) in close proximity to the trimmer cutting head 10 from contacting the blades 34 partially embedded within the cutting belt 14, thereby protecting not only the objects but also the blades. It also prevents the cutting belt 14 from contacting the ground, thereby reducing damage to the blades and eliminating ground scalping, thereby greatly reducing dangerous flying debris.

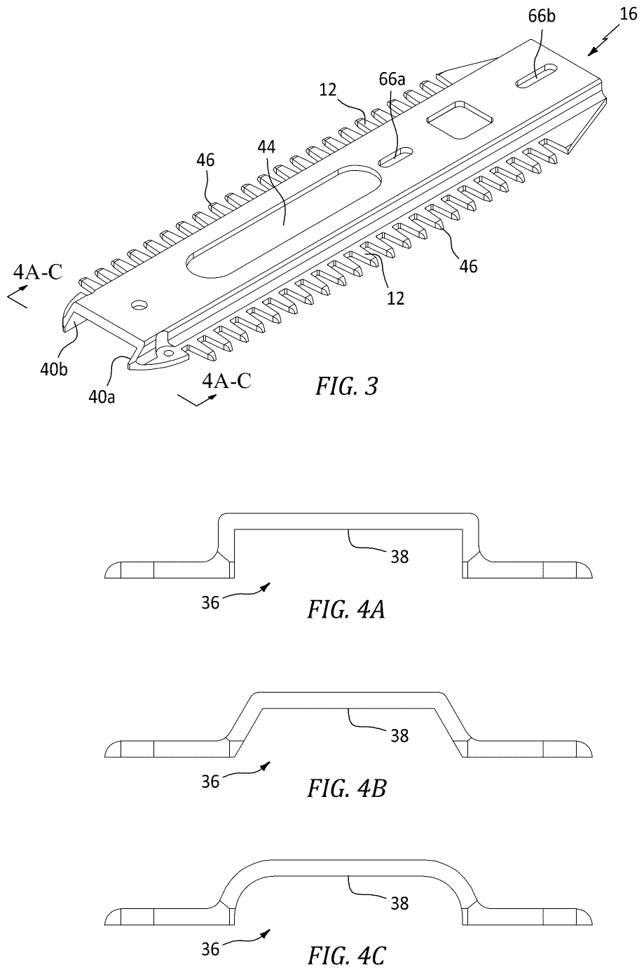

While the guard frame 16 may adopt a planar configuration, resting on the same plane as the opposing sets of spaced, comb-like, channeling teeth 18a, 18b, the present inventor has discovered that a non-planar configuration such as that described below offers anti-flexing and anti-fatigue properties. In this exemplary embodiment, which is shown in FIGS. 1-3, the guard frame 16, which is positioned preferably from about 0.32 to about 0.95 centimeters (cm) below the cutting belt 14, has a central channel 36 with a preferred channel depth of from about 0.86 to about 1.37 cm, that extends along the entire longitudinal axis of the frame 16 and acts as a skid plate. The central channel 36 has a base 38 and opposite side walls 40a, 40b, each with an opposing set of spaced, comb-like, channeling teeth 18a, 18b, extending substantially perpendicular thereto and terminating in chamfered edges 42a d. The cross-sectional shape of the central channel 36 is not limited and may adopt any open cross-sectional shape. In preferred embodiments, as best shown in FIGS. 4A-4C, the side walls form either a substantially perpendicular angle (FIG. 4A), or obtuse angle (FIG. 4B) relative to base 38, or the central channel 36 adopts a conic or U-shaped, open cross-section (FIG. 4C).

The central channel 36 in this exemplary embodiment has a plurality of through-holes along its longitudinal axis for receiving means for securing the idle pulley 24 and the gear head mounting bracket 32, as well as a through-hole 44 that serves as a viewing window allowing an operator of the inventive trimmer (when in motion/operation) to view the underlying ground while improving air circulation by allowing dirt and cut vegetation to fall through the viewing window away from the revolving cutting belt.

As best shown in FIG. 3, the comb-like, channeling teeth 12, which protrude substantially perpendicularly from side walls 40a, 40b, narrow or taper toward a distal end 46 forming a generally blunt end, and are spaced apart from adjacent teeth by a distance ranging from about 0.48 to about 0.95 cm, at the widest end, and from about 0.83 to about 1.31 cm at the narrowest, tapered end. In a preferred embodiment, the comb-like, channeling teeth 12 are evenly spaced from each other, and/or are made using tapered aluminum or titanium. The sets of comb-like, channeling teeth 18a, 18b, may be integrally formed with frame 16, or may be formed as separate strips or structures for assembly onto the side walls 40a, 40b.

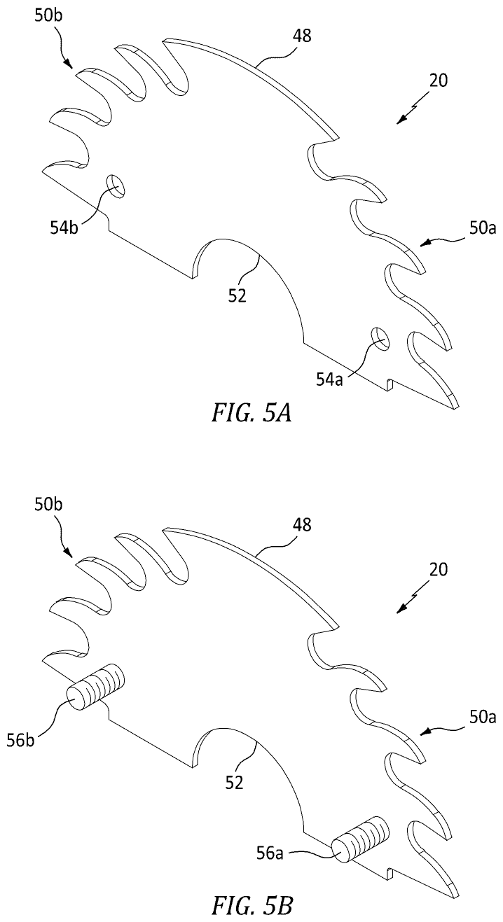

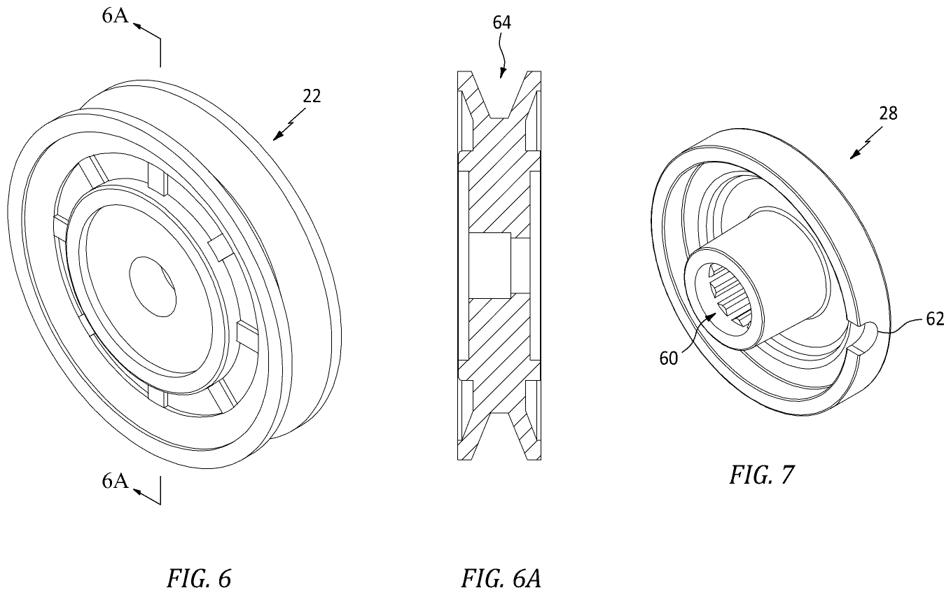

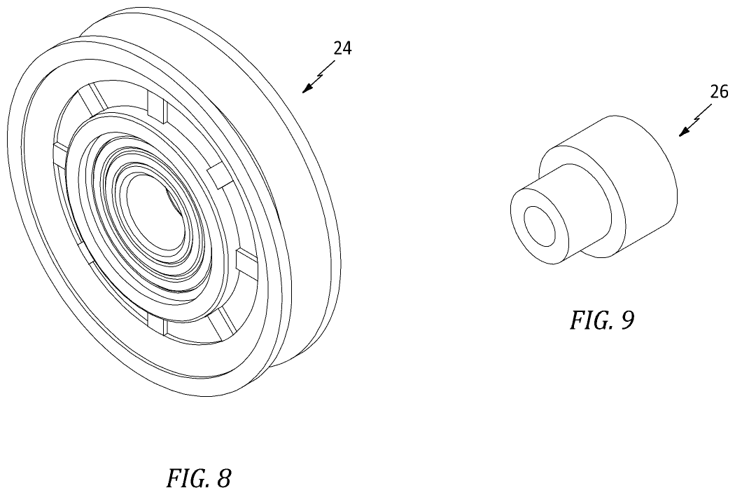

As best shown in FIGS. 5A and 5B, the front nose guard plate 20 is an arch shaped plate with a solid top or crown 48, and book matched curved, spaced, comb-like, channeling teeth 50a, 50b, on either side of the solid top or crown 48 on the front nose guard plate 20, which complements and connects the sets of comb-like, channeling teeth 18a, 18b, of the frame 16. The plate has a cut-out or notch 52 for matting against the stand-off bushing 26, and a set of opposing through-holes 54a, 54b for receiving suitable affixation means (FIG. 5A), or a pair of affixed threaded studs 56a, 56b (with complimentary nuts 57a, 57b) (FIG. 5B), for mounting the plate onto the frame 16. The present invention also contemplates a one-piece construction where the front nose guard plate 20 and the frame 16 form one unitary structure. The front nose guard plate 20 may have a high visibility color rendering it easier to see, especially in low light.

The elongate cutting guard frame 16 may be formed from metallic material(s) (e.g., aluminum, stainless steel), alloy(s), plastic material(s) ((e.g., polyvinyl chloride, a thermoplastic material, a thermoset material (e.g., High density Polyethylene (HDPE), etc.) and/or a combination thereof and/or any other suitable material(s).

While the elongate cutting guard frame 16 can have a number of different sizes, in a preferred embodiment, it has a length ranging from about 25.4 to about 43.2 cm (more preferably, from about 33.0 to about 38.1 cm), a width ranging from about 7.62 to about 12.7 cm (more preferably, from about 7.62 to about 10.16 cm), and a height ranging from about 0.95 to about 3.18 cm (more preferably, from about 1.27 to about 2.54 cm).

### Drive Pulley and Drive Pulley Mount Idle Pulley and Stand off Bushing

Referring now to FIGS. 6, 6A, and 7, and as alluded to above, a pair of spaced apart pulleys, namely, the drive pulley 22 and the idle pulley 24, are rotatably mounted on opposing distal ends of the elongate cutting guard frame 16.

The drive pulley 22 is rotatably mounted onto an assembly comprising: the gearhead 30 (with drive shaft 58); the gearhead mounting bracket 32; and the drive pulley mount 28, with the gearhead mounting bracket 32 mounted onto the cutting guard frame 16. The drive pulley mount 28 has a spline or keyed bore 60, which mates with the splines on the gearhead drive shaft 58. A motor (e.g., an electric, gas, or battery-operated motor) (not shown) is internally housed within the handle (also not shown) which extends from the gearhead 30 and serves to power the drive shaft 58 for engaging and rotationally driving the drive pulley 22. The drive pulley mount 28 also has a notch 62, which allows for use of a rod to inhibit rotation of the gearhead drive shaft 58 when tightening or loosening a locking nut on the end of the shaft 58.

As best shown in FIGS. 2, 8, and 9, the idle pulley 24 is rotatably mounted onto a standoff bushing 26 using mounting screw or bolt 27a and complimentary washer/nut combination 27b, which serves to position the idle pulley 24 above the nose guard plate 20.

Both the drive pulley 22 and the idle pulley 24 have a grooved (e.g., a U-shaped or V-shaped) profile 64 which mates with the profile of the cutting belt 14, thereby causing a positive belt engagement, preventing the belt from being dislodged, or from slipping off of the pulleys during operation of the inventive trimmer cutting head 10.

The drive pulley 22 and the idle pulley 24 may have the same or different diameters. In an exemplary embodiment, both pulleys have an outside diameter ranging from about 7.62 to about 12.70 cm, preferably, from about 7.62 to about 10.16 cm. In a preferred embodiment, identical pulleys are used as the drive pulley and as the idle pulley.

Both pulleys may be made from any suitable material including, but not limited to, metal (e.g., aluminum), ferromagnetic material (e.g., steel), or synthetic plastic material (e.g., nylon), and in a preferred embodiment, are both prepared from aluminum. In a more preferred embodiment, the aluminum pulleys comprise slots and/or holes for weight reduction.

In another preferred embodiment, the drive pulley 22 and the idle pulley 24 each employ a sealed bearing allowing it to rotate smoothly on its respective shaft while preventing external contaminants like dirt and moisture from entering the bearing.

The present invention further contemplates the use of more than two pulleys. For example, two idle pulleys may be used on opposing distal ends of the cutting guard frame 16, one idle pulley being positioned next to the drive pulley.

### Continuous Cutting Belt

The continuous cutting belt 14, which is wrapped around and rotated (preferably counterclockwise) by the drive pulley 22, may be selected from the group of a V-belt, a flat belt, a toothed belt, and a round belt with a circular cross-section, and may be made of any suitable material including natural or synthetic rubber or similar material. In a preferred embodiment, the continuous cutting belt is a V-belt. The key feature of a V-belt is the V-shaped cross-section which allows it to generate a wedging action within the pulley grooves, minimizing slippage. V-belts are typically made from a fiber reenforced rubber composition (e.g., a rubber composition obtained by dispersing nylon short fibers and cotton short fibers into ethylene propylene diene monomer (EPDM)). As will be readily appreciated by those skilled in the art, externally wrapped cords and/or internal strengthening cords on or within belt 14 provide for a firmer and stronger attachment between the belt 14 and the cutting blade inserts 34.

The continuous cutting belt 14 transfers power between pulleys 22, 24, via friction, where the friction is multiplied by the mechanical advantage of the wedging principle. Correct cutting belt operation is dependent on proper tension of the belt. Tensioning the cutting belt 14 about the pulleys 22, 24, may be adjusted using elongated slots 66a, 66b, disposed on frame 16, as shown in FIGS. 2 and 3. The gear head mounting bracket 32, which supports the drive pulley 22, is anchored to the frame 16 by machine screws 68a, 68b, which are moveable along the elongate slots and when correctly positioned in terms of belt tension, are tightened and locked in place thus securing the drive pulley 22.

### Cutting Blade Inserts

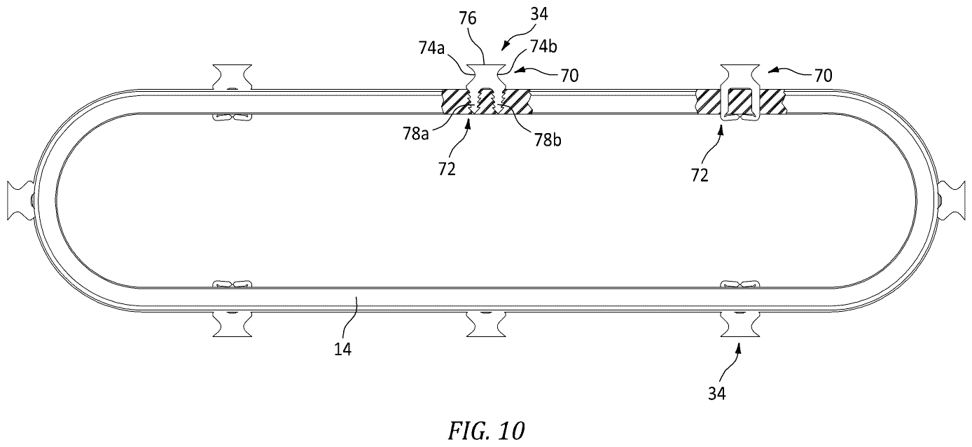

Referring to FIG. 10, the cutting blade inserts 34 are shown as comprising a cutting blade portion 70 and an anchoring portion 72, the cutting blade portion 70 having two generally parallel side cutting edges 74a, 74b, and a longitudinally extending top edge 76, the anchoring portion 72 comprising a pair of legs 78a, 78b, spaced apart from one another, projecting downwardly from the cutting blade portion 70.

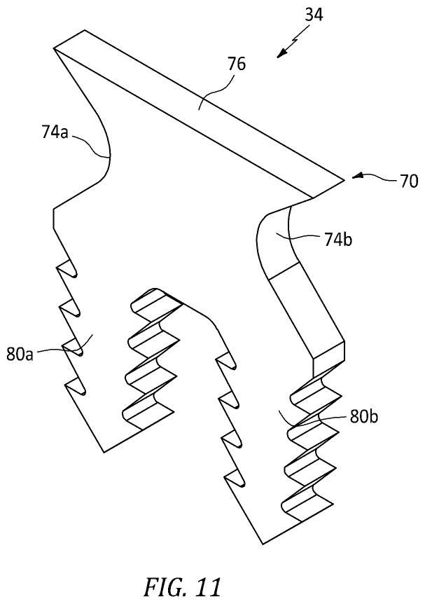

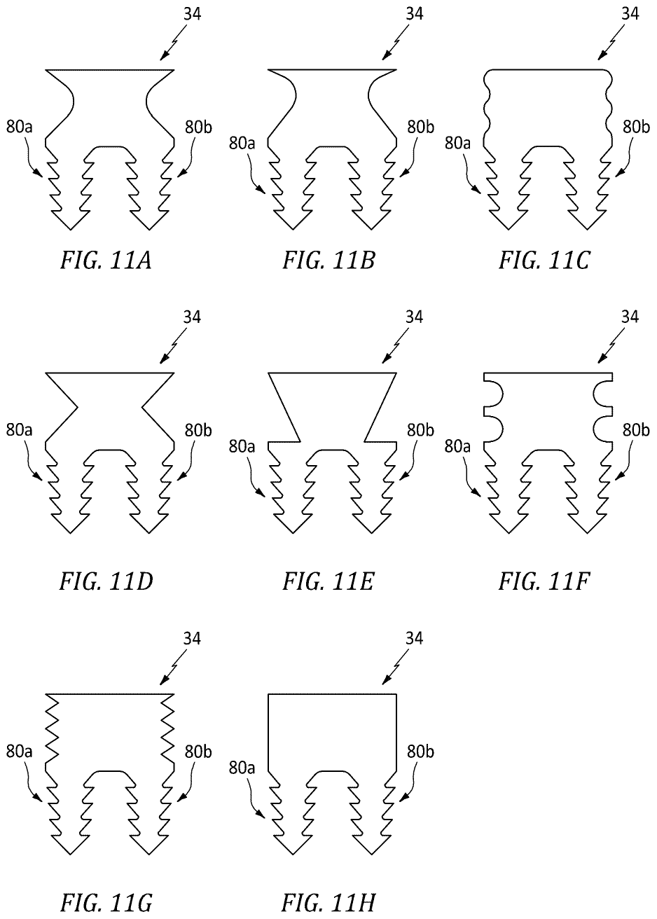

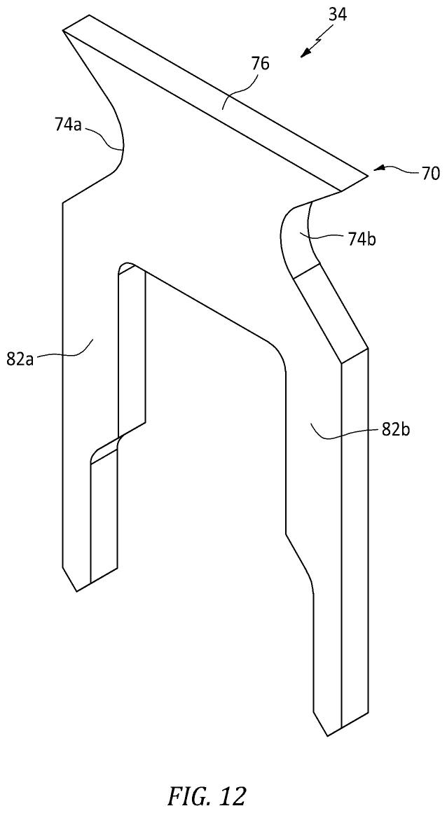

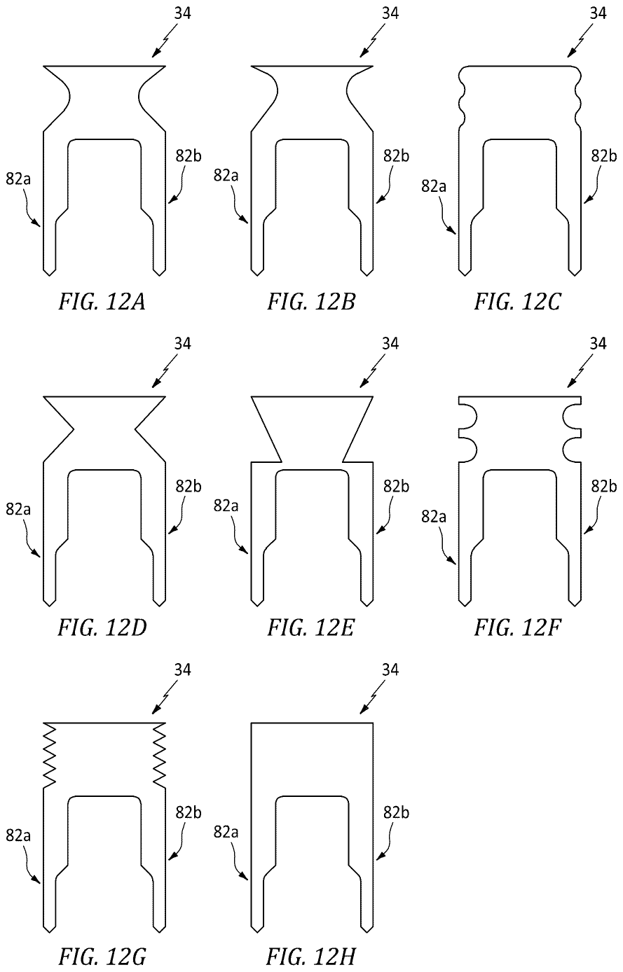

As best shown in FIGS. 11 and 12, in two exemplary embodiments, the anchoring portion of the cutting blade inserts have either a pair of “barbed” legs 80a, 80b, or a pair of “staple-like” legs 82a, 82b, respectively. A mechanical device is used to drive the cutting blade inserts 34 into the continuous cutting belt 14. For the cutting blade inserts with a pair of “barbed” legs, the legs are fully embedded within the continuous cutting belt 14. For the cutting blade inserts with a pair of “staple-like” legs, the ends of the legs project from the belt 14 and are then bent up against the belt to firmly bind the insert to the belt. In a preferred embodiment, the cutting blade insert 34 has a pair of “staple-like” legs 82a, 82b, which may serve to provide a firmer and stronger attachment.

As best shown in FIGS. 11A-11H and in FIGS. 12A-12H, the side cutting edges 74a, 74b, of cutting blade portion 70 of the cutting blade insert 34 can adopt the same or different shapes or profiles, which include, but are not limited to: a center curve profile (FIGS. 11A and 12A); an offset curve profile (FIGS. 11B and 12B); a wavy cut profile (FIGS. 11C and 12C); a centered V profile (FIGS. 11D and 12D); a wedge tip profile (FIGS. 11E and 12E); a curve notch profile (FIGS. 11F and 12F); a serrated profile (FIGS. 11G and 12G); and a straight edge profile (FIGS. 11H and 12H).

Opposing side cutting edges 74a, 74b, of the cutting blade insert 34 may have the same or different cutting edge profiles. For example, opposing side edges may both have the same edge profile, or one side may have a cutting edge profile that differs from the other or opposing cutting edge profile (e.g., a wavy edge profile and an opposing centered V profile).

The cutting blade inserts used along the longitudinal length of the cutting belt may be the same or different. For example, the inserts may have different cutting blade portions and/or different anchoring legs. Further, the cutting blade inserts may be angled relative to the longitudinal axis of the continuous cutting belt 14 and/or may adopt a single-row linear arrangement on the cutting belt, a double-row linear arrangement, or a multi-row staggered linear arrangement.

The cutting blade inserts 34 demonstrate a suitable combination of mechanical properties such as strength, toughness and wear resistance and may be prepared from a material including, but not limited to, high-carbon steel, stainless steel, tungsten carbides, and the like.

In an exemplary embodiment, the cutting blade inserts 34 are color coded indicating the type of cutting blade portion and/or anchoring portion of the insert.

While the cutting blade inserts 34 may have a number of different sizes, in a preferred embodiment, each insert has a length or height above the cutting belt 14 ranging from about 0.51 to about 1.02 cm (more preferably, from about 0.64 to about 0.89 cm), a width ranging from about 0.95 to about 1.59 cm (more preferably, from about 1.11 to about 1.43 cm), and a thickness ranging from about 0.08 to about 0.16 cm (more preferably, from about 0.09 to about 0.15 cm).

### Gear Head and Gear Head Mounting Bracket

As best shown in FIG. 2, the gear head 30, which is driven by the motor, operates the drive shaft 58, which serves to rotate the drive pulley 22. The gear head 30 has a mounting plate 84 with through holes 86a, 86b (not shown), 86c, for attachment to the gear head mounting bracket 32 using mounting screws 88a, 88b, 88c. In one exemplary embodiment, the gear head 30 is an articulating gear head, which moves or pivots on multiple axes allowing for flexible movement and the ability to reach different angles.

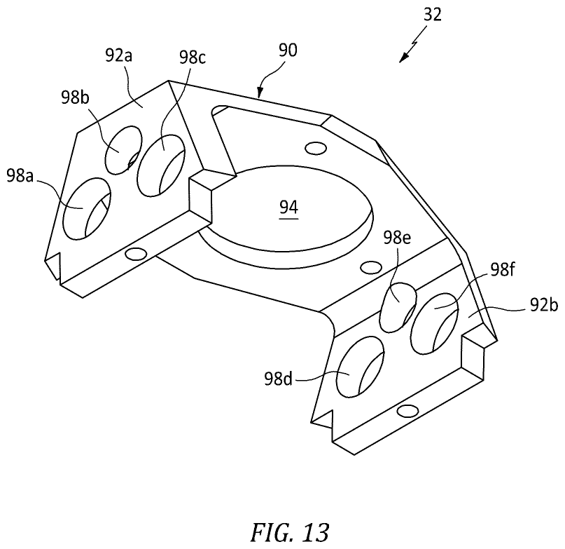

Referring now to FIG. 13, the gear head mounting bracket 32 has a table-like shape with a top surface 90 and two opposing legs 92a, 92b. The top surface 90 has a central through hole 94 for passage of the drive shaft 58, which then extends through the drive pulley mount 28 and the drive pulley 22, which are both secured on the drive shaft using drive pulley locking nut 96. The two legs 92a, 92b, have a height and are spaced apart at a distance sufficient to accommodate the width or diameter of the drive pulley mount 28 and the drive pulley 22 and have a plurality of through holes 98a-98f, which allow for cut vegetation to flow away from the drive pulley during operation of the inventive device. The mounting bracket 32 is mounted onto the frame 16 using mounting screws or bolts 100a, 100b.

Similar to the elongate cutting guard frame 16, the gear head 30 and gear head mounting bracket 32 may be formed from metallic material(s) (e.g., aluminum, stainless steel), alloy(s), plastic material(s) ((e.g., polyvinyl chloride, a thermoplastic material, a thermoset material (e.g., High density Polyethylene (HDPE), etc.) and/or a combination thereof and/or any other suitable material(s).

Although exemplary embodiments have been shown and described, it will be clear to those of ordinary skill in the art that a number of changes, modifications, or alterations to the invention as described can be made. All such changes, modifications, and alternations should therefore be seen as within the scope of the disclosure.

1. A vegetation trimmer cutting head which comprises an elongate cutting guard frame having a longitudinal axis, front and rear distal ends, and sets of spaced, comb-like, channeling teeth, each having a generally blunt distal end, positioned at least along opposing longitudinal sides of the guard frame, and a cutting belt having a cutting path, the cutting belt positioned above the elongate cutting guard frame, wherein during operation of the vegetation trimmer cutting head, the sets of spaced, comb-like, channeling teeth channel vegetation into the cutting path of the cutting belt, while preventing surface damage to any objects contacted by the trimmer cutting head,
wherein the vegetation trimmer cutting head has an arch shaped front nose guard plate fixably attached to the front distal end of the elongate cutting guard frame,
wherein the cutting belt has a plurality of spaced cutting blade inserts partially embedded therein, wherein the cutting blade inserts are remote from the sets of spaced, comb-like, channeling teeth, with each cutting blade insert made up of a cutting blade portion and an anchoring portion,
wherein the anchoring portion of each cutting blade insert has a pair of legs spaced apart from one another along their entire length, each leg extending an equal distance downwardly from the cutting blade portion.

2. The vegetation trimmer cutting head of claim 1, wherein each cutting blade portion has dual cutting edges.

3. The vegetation trimmer cutting head of claim 2, wherein the cutting blade portion of each cutting blade insert has dual cutting edges in the form of two opposing side cutting edges, and a longitudinally extending top edge.

4. The vegetation trimmer cutting head of claim 3, wherein the pair of legs may be the same or different shape and are selected from the group of barbed legs, staple legs, or a combination of barbed legs and staple legs.

5. The vegetation trimmer cutting head of claim 3, wherein the two opposing side cutting edges of the cutting blade portion of each cutting blade insert have shapes or profiles that may be the same or different and which are selected from the group of straight edge profiles, center curve profiles, offset curve profiles, wavy cut profiles, centered V profiles, wedge tip profiles, curved notch profiles, and serrated profiles.

6. The vegetation trimmer cutting head of claim 1, wherein the elongate cutting guard frame has a central channel that extends along the entire longitudinal axis of the frame, the central channel having a base and opposing side walls, wherein each opposing set of spaced, comb-like, channeling teeth extend substantially perpendicularly from an opposing side wall.

7. The vegetation trimmer cutting head of claim 1, which comprises:
the elongate cutting guard frame having an outer perimeter, and the sets of spaced, comb-like, channeling teeth positioned at least along opposing longitudinal sides of the guard frame;
at least two pulleys including a drive pulley and an idle pully disposed on opposing distal ends of the guard frame; and
the cutting belt, wherein the cutting belt is an endless cutting belt having a plurality of spaced cutting blade inserts partially embedded therein, wrapped around the drive pulley and the idle pully, and movable along the cutting path, the cutting belt being set back or offset from the perimeter of the guard frame,
wherein, each set of spaced, comb-like, channeling teeth work in cooperation with the cutting blades by channeling vegetation into the cutting path of the cutting belt, while preventing objects in proximity to the trimmer cutting head from contacting the cutting blade inserts.

8. The vegetation trimmer cutting head of claim 7, wherein the plurality of spaced cutting blade inserts are equally spaced along the cutting belt.

9. The vegetation trimmer cutting head of claim 7, wherein each cutting blade insert comprises a cutting blade portion and an anchoring portion, wherein each cutting blade portion has dual cutting edges.

10. The vegetation trimmer cutting head of claim 9, wherein the cutting blade portion of each cutting blade insert has dual cutting edges in the form of two opposing side cutting edges, and a longitudinally extending top edge, wherein the anchoring portion of each cutting blade insert has a pair of legs spaced apart from one another that extend downwardly from the cutting blade portion.

11. The vegetation trimmer cutting head of claim 10, wherein the pair of legs may be the same or different shape and are selected from the group of barbed legs, staple legs, or a combination of barbed and staple legs.

12. The vegetation trimmer cutting head of claim 11, wherein the pair of legs are both barbed legs.

13. The vegetation trimmer cutting head of claim 11, wherein the pair of legs are both staple legs.

14. The vegetation trimmer cutting head of claim 10, wherein the two opposing side cutting edges of the cutting blade portion of each cutting blade insert have shapes or profiles that may be the same or different and which are selected from the group of straight edge profiles, center curve profiles, offset curve profiles, wavy cut profiles, centered V profiles, wedge tip profiles, curved notch profiles, and serrated profiles.

15. The vegetation trimmer cutting head of claim 14, wherein the two opposing side cutting edges each have a center curve profile.

16. The vegetation trimmer cutting head of claim 7, wherein the elongate cutting guard frame has a central channel that extends along the entire longitudinal axis of the frame, the central channel having a base and opposing side walls, wherein each opposing set of spaced, comb-like, channeling teeth extend substantially perpendicularly from an opposing side wall.

17. The vegetation trimmer cutting head of claim 16, wherein each opposing set of spaced, comb-like, channeling teeth has opposing distal ends with chamfered edges.

18. The vegetation trimmer cutting head of claim 16, wherein the central channel has a large through-hole, which serves as a viewing window allowing an operator to view the ground underneath the trimmer cutting head.

19. The vegetation trimmer cutting head of claim 7, wherein the spaced, comb-like, channeling teeth each narrow or taper forming a generally blunt distal end.

20. (canceled)

21. The vegetation trimmer cutting head of claim 7, wherein each set of spaced, comb-like, channeling teeth of the elongate cutting guard frame has opposing distal ends with chamfered edges, allowing it to smoothly transition into the front nose guard plate.

22. A handheld vegetation trimmer cutting head, which comprises the vegetation trimmer cutting head of claim 1, and a handle, which extends therefrom to hold and guide the trimmer cutting head.

23. The handheld vegetation trimmer cutting head of claim 22, wherein a motor is internally housed within the handle to power the cutting head.

24. The handheld vegetation trimmer cutting head of claim 23, wherein the motor is an electric, gas, or battery-operated motor.

25. A method for trimming vegetation, which comprises using the handheld vegetation trimmer cutting head of claim 22, to trim vegetation in areas of a yard where a lawn mower cannot reach.

26. A vegetation trimmer cutting head which comprises an elongate cutting guard frame having a longitudinal axis, front and rear distal ends, and sets of spaced, comb-like, channeling teeth, each having a generally blunt distal end, positioned at least along opposing longitudinal sides of the guard frame, and a cutting belt having a cutting path, the cutting belt positioned above the elongate cutting guard frame, wherein during operation of the vegetation trimmer cutting head, the sets of spaced, comb-like, channeling teeth channel vegetation into the cutting path of the cutting belt, while preventing surface damage to any objects contacted by the trimmer cutting head,
wherein the vegetation trimmer cutting head has an arch shaped front nose guard plate fixably attached to the front distal end of the elongate cutting guard frame, which is contiguous with and connects the sets of spaced, comb-like, channeling teeth, and wherein the arch shaped front nose guard plate is made up of has book matched, curved, spaced, comb-like, channeling teeth on either side of a co-extensive, central, solid top or crown.

27. A vegetation trimmer cutting head which comprises an elongate cutting guard frame having a longitudinal axis, front and rear distal ends, and sets of spaced, comb-like, channeling teeth, each having a generally blunt distal end, positioned at least along opposing longitudinal sides of the guard frame, and a cutting belt having a cutting path, the cutting belt positioned above the elongate cutting guard frame, wherein during operation of the vegetation trimmer cutting head, the sets of spaced, comb-like, channeling teeth channel vegetation into the cutting path of the cutting belt, while preventing surface damage to any objects contacted by the trimmer cutting head,
wherein the cutting belt has a plurality of spaced cutting blade inserts partially embedded therein, wherein the cutting blade inserts are remote from the sets of spaced, comb-like, channeling teeth, with each cutting blade insert made up of a cutting blade portion and an anchoring portion,
wherein the anchoring portion of each cutting blade insert has a pair of legs spaced apart from one another along their entire length, each leg extending an equal distance downwardly from the cutting blade portion,
wherein the vegetation trimmer cutting head has an arch shaped front nose guard plate fixably attached to the front distal end of the elongate cutting guard frame, which is contiguous with and connects the sets of spaced, comb-like, channeling teeth, and
wherein the arch shaped front nose guard plate is made up of book matched, curved, spaced, comb-like, channeling teeth on either side of a co-extensive, central, solid top or crown.

28. The vegetation trimmer cutting head of claim 1, wherein each leg of the pair of legs of the anchoring portion of each cutting blade insert terminates to a point.
